(19) United States
(12) Patent Application Publication
(10) Pub. No.: US 2012/0247713 A1
(43) Pub. Date: Oct. 4, 2012

(54) METHOD AND SYSTEM FOR BATTERY TEMPERATURE CONTROL IN A HYBRID OR ELECTRIC VEHICLE

(75) Inventor: J. Axel Radermacher, Foothill Ranch, CA (US)

(73) Assignee: Fisker Automotive, Inc.

(21) Appl. No.: 13/516,219

(22) PCT Filed: Dec. 15, 2010
(86) PCT No.: PCT/US10/60495

§ 371 Date: Jun. 14, 2012

Related U.S. Application Data
(60) Provisional application No. 61/286,589, filed on Dec. 15, 2009.

(51) Int. Cl. H01M 10/50; B60H 1/00

(52) U.S. Cl. 165/41; 429/71; 429/62; 429/50

(57) ABSTRACT

A battery temperature control system for a vehicle having a battery as a power source includes a battery module including at least one battery cell and at least one liquid distribution tube member positioned adjacent the battery module for circulating a non-conductive liquid therethrough. The liquid distribution tube defines at least one distribution port adjacent the at least one battery cell. A collection tray is connected to and positioned at one end of the liquid distribution tube member. A liquid pump communicates with the liquid distribution tube member for distributing the liquid throughout the liquid distribution tube member. A heat exchanger is disposed in the liquid distribution tube member to modify the temperature of the liquid. The distribution port delivers the liquid to contact the at least one battery cell in the battery module. The liquid tray collects the liquid after contacting the at least one battery cell.

### CROSS-REFERENCE TO RELATED APPLICATIONS

This application claims the benefit of U.S. Provisional Patent Application No. 61/286,589, filed Dec. 15, 2009, the disclosure of which is incorporated herein by reference in its entirety.

### BACKGROUND

The present disclosure relates generally to hybrid or electric vehicles, and more particularly to a battery for use in a hybrid or electric powered vehicle.

### DESCRIPTION OF THE RELATED ART

Vehicles, such as motor vehicles, utilize an energy source in order to provide power to operate the vehicle. While petroleum based products, such as gasoline, dominate as an energy source in traditional combustion engines, alternative energy sources are available, such as methanol, ethanol, natural gas, hydrogen, electricity, solar or the like. A hybrid powered vehicle, referred to as a “hybrid vehicle,” utilizes a combination of energy sources in order to power the vehicle. For example, a battery may be utilized in combination with the traditional combustion engine to provide power to operate the vehicle. Such vehicles are desirable since they take advantage of the benefits of multiple fuel sources in order to enhance performance and range characteristics of the hybrid vehicle relative to a comparable gasoline powered vehicle.

An example of a hybrid vehicle is a vehicle that utilizes a combination of electric and gasoline engine as a power source. An electric vehicle is environmentally advantageous due to its low emissions characteristics and the general availability of electricity as a power source. The battery may be quite large, depending on the energy requirements of the vehicle, and will generate heat that is dissipated using various techniques. Typically coolant, such as a liquid or a gas, is used as a medium for transferring heat from the battery. The coolant cools the battery through heat sink and a cold plate and is often cooled by the air conditioning system. This may require complicated arrangements to achieve desired heat transfer out of the battery cell. Various strategies are available to cool the battery, such as the circulation of conditioned air or a fluid in or around the battery case, however, these systems require various hardware and relatively complicated arrangements. Thus, there is a need in the art for an electric or hybrid electric powered vehicle with an improved temperature control, particularly a cooling system and method for achieving desirable battery temperature control.

### SUMMARY

Accordingly, the present disclosure relates to a battery temperature control system for a vehicle having a battery as a power source. The system includes (a) a battery module including at least one battery cell; (b) at least one liquid distribution tube member positioned adjacent the battery module for circulating a non-conductive liquid therethrough, wherein the liquid distribution tube member defines at least one distribution port adjacent the at least one battery cell to deliver the liquid to contact the at least one battery cell in the battery module; (c) a collection tray connected to and positioned at one end of the liquid distribution tube member, wherein the liquid tray collects the liquid after contacting the at least one battery cell; (d) a liquid pump in communication with the liquid distribution tube member for distributing the liquid throughout the liquid distribution tube member; and (e) a heat exchanger disposed in the liquid distribution tube member to modify the temperature of the liquid.

A method of maintaining a desired temperature of a battery in a hybrid or fully electric vehicle is provided. The method includes the steps of: (a) distributing a non-conductive liquid defining a temperature from a collection tray to a distribution port on a tube system; (b) passing the liquid through the heat exchanger to raise or lower the temperature of the liquid; (c) delivering the liquid through the distribution port to directly contact at least one battery cell in a battery module; and (d) collecting the liquid distributed to the battery cell in the collection tray.

The present disclosure further provides for a method of maintaining a desired temperature in a hybrid or electric vehicle that includes the steps of: (a) distributing a non-conductive liquid defining a temperature from a collection tray to a distribution port on a tube system; (b) passing the liquid through the heat exchanger to raise or lower the temperature of the liquid; (c) delivering the liquid through the distribution port to directly contact electrical devices in the vehicle; and (d) collecting the liquid distributed to the battery cell in the collection tray.

During operation, the battery generates a significant amount of heat. This heat can be dissipated in order to improve battery life. An advantage of the present disclosure is that a system and method of battery temperature control is provided so that the vehicles heat and cool their batteries to improve battery life and overall vehicle performance. Another advantage of the present disclosure is that a temperature control system for a battery is provided that integrates cooling or heating and sealing in one unit. Still another advantage of the present disclosure is that the cooling system reduces the need for complicated fluid distribution arrangements to manage battery temperature. Yet another advantage of the present disclosure is that the integrated system provides direct conductive heat transfer. A further advantage of the present disclosure is that heat transferred from the battery can be redistributed to other areas of the vehicle. Still a further advantage of the present disclosure is that the battery system seals the battery from environmental intrusion.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of an exemplary hybrid vehicle.

FIG. 2 is a perspective cut-away view of an exemplary hybrid vehicle showing a battery.

FIG. 3 is a perspective view of an exemplary battery temperature control system.

FIG. 4 is a flowchart illustrating a method of battery temperature control using the system of FIGS. 1-3.

### DESCRIPTION

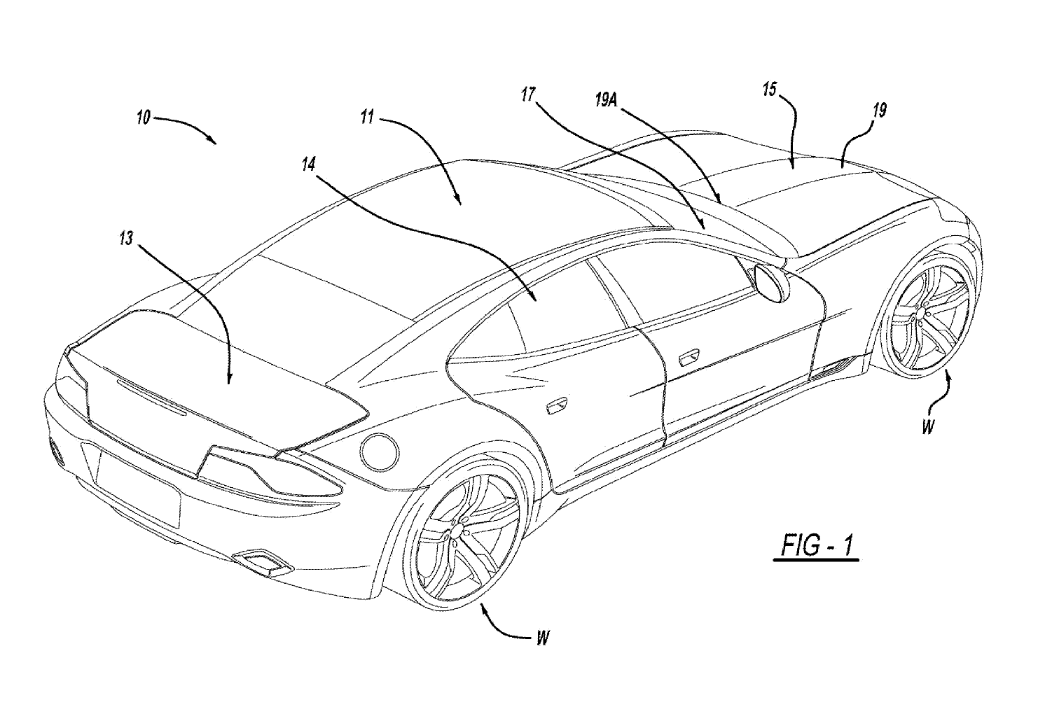

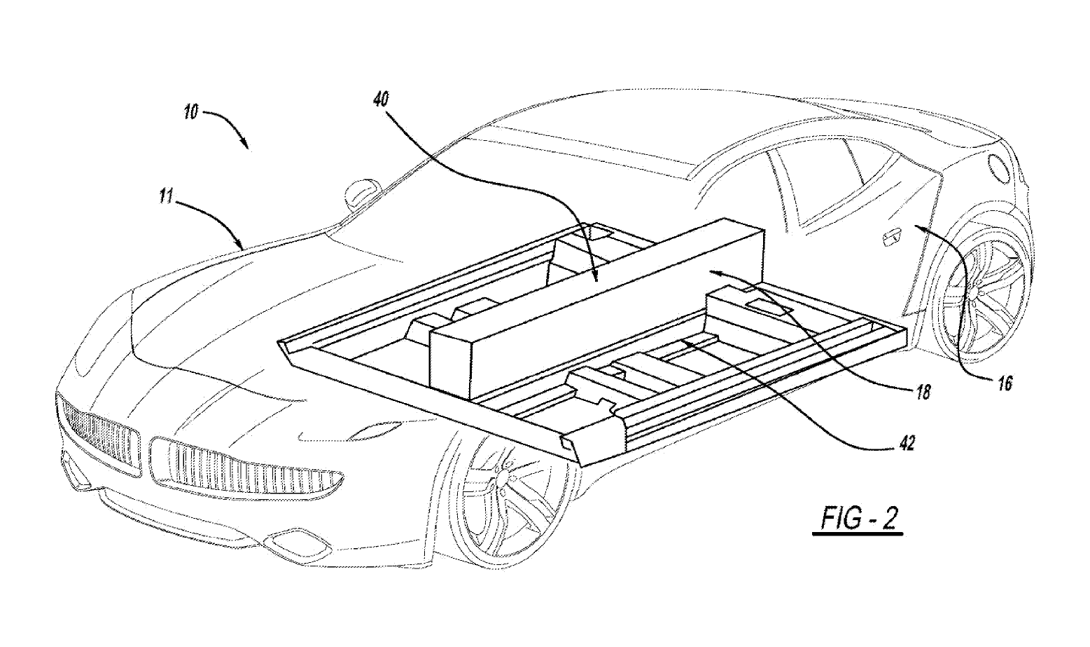

Referring to FIGS. 1 and 2, an exemplary hybrid vehicle 10 is illustrated. Vehicle 10 can be any hybrid vehicle including a solar and electric powered vehicle, a combustion engine and electric vehicle, a plug-in hybrid vehicle having a battery that obtains an electrical charge from a standard electrical outlet, or a fully electric battery powered vehicle. Generally, vehicle 10 includes a body structure 11 having a frame surrounding and typically enclosing an interior space 17 referred to as a passenger compartment 17. A rear compartment 13, often used as a trunk or luggage compartment 13 extends rearwardly from the passenger compartment 17. Typically the passenger compartment 17 and luggage compartment 13 are separated by passenger seats 14. Often the seats 14 are foldable and/or removable to allow for storing and carrying larger objects thereby effectively extending the size of the rear compartment 13. A front or engine compartment 15 typically extends forwardly from the passenger compartment 17 and is covered from above by a hood 19. The hood is pivotably mounted at a proximal end 19A of the front compartment 15 adjacent the passenger compartment 17 to allow access to mechanical and electrical components mounted in the front compartment 15. A power source, such as an engine, typically engage a drive shaft (not shown) and in combination with the wheels W define a drive train 12 (also referred to as a power train), commonly referred to as a group of components that generate power and deliver it to the road surface. In certain embodiments, the engine may be located in or below the rear compartment 13.

In an example of FIG. 2, the vehicle 10 is a plug-in hybrid vehicle that is gasoline and electric powered. The vehicle 10 may be a passenger car, truck, or other type of vehicle having a battery system 18. In another example, the vehicle is a dedicated battery powered vehicle.

The vehicle 10 includes a power train 12 that controls the operation of the vehicle. In this example, the power train is a plug-in hybrid, and includes an electrically powered motor and motor controller. The vehicle may also include a gasoline powered engine 16 that supplements the electric motor when required under certain operating conditions. The electrical energy is stored in an energy storage device, such as the battery 18. The battery 18 may be a single unit, or a plurality of modules arranged in a predetermined manner, such as in series to be described in more detail below. Various types of batteries are available, such as lead acid, or lithium-ion or the like. The battery 18 is contained within a battery housing 40. Various strategies are available to cool the battery, such as the circulation of conditioned air or a fluid in or around the battery case 40. An example of a cooling technique is disclosed in commonly assigned patent application PCT/US10/41332 filed on Jul. 8, 2010 and claiming priority to U.S. Patent Application Ser. No. 61/223,902 filed on Jul. 8, 2009 and incorporated herein by reference in its entirety. The vehicle 10 may include more than one type of battery 18 or energy storage device. The battery 18 supplies the power in the form of electricity to operate various vehicle components. In this example, there is a low voltage battery that provides electrical power to vehicle components such as the various auxiliary systems and a high voltage battery (i.e. 400 V traction battery) that provides electrical power to an electric drive motor. The battery may be in communication with a control system that regulates the distribution of power within the vehicle, such as to the electric drive motor, or a vehicle component or other accessories or the like. In this example, the high voltage battery receives electrical energy from a plug-in source, and the low voltage battery receives electrical energy from a solar source and from the higher voltage battery as needed.

The battery 18 is supported within the vehicle by a battery tray 42. In this example, the battery 18 and battery tray 42 extend longitudinally along the length of the vehicle. The battery tray is fabricated from a metal material, such as Aluminum or the like. The battery tray is secured to the vehicle frame 11 using a fastener, such as a bolt. A seal is applied between a flange portion of the base member and the battery housing to prevent the intrusion of elements such as moisture or dirt or like into the interior of the battery. An example is a sealant is rubber or foam or adhesive, or the like. The housing 40 is a generally box-like structure that provides additional protection to the battery 18. The housing 40 is secured to the battery tray, such as using a fastener.

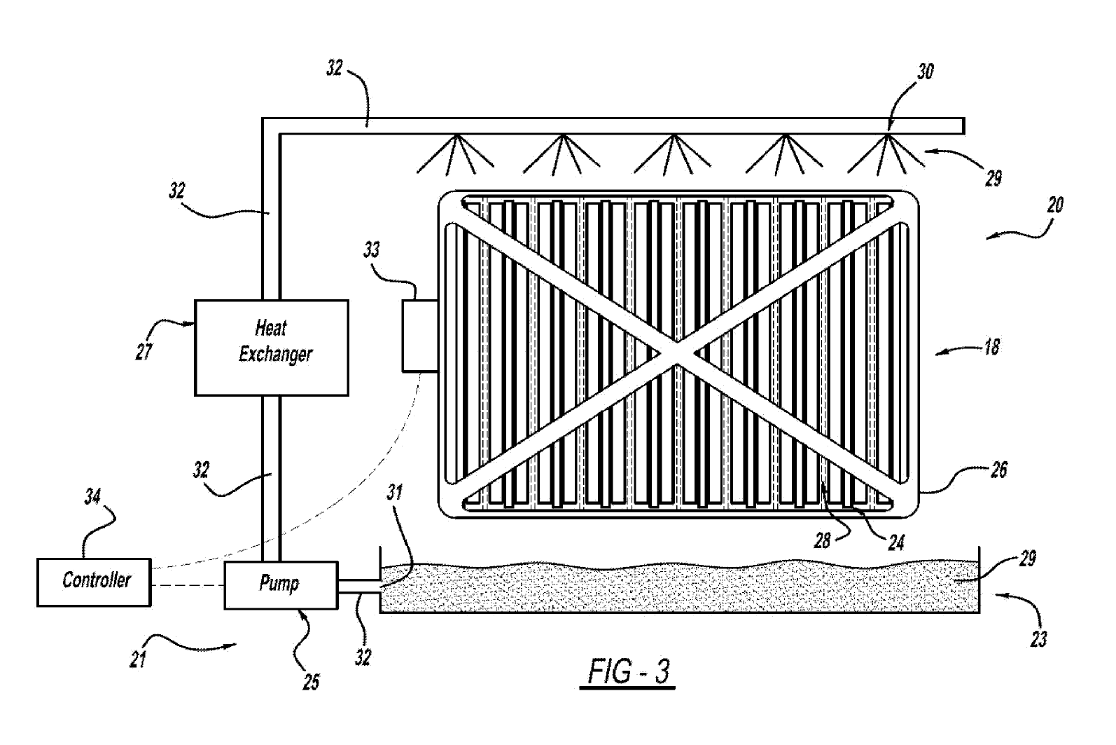

Referring to FIG. 3, a battery temperature control system 20 is shown. System 20 can be incorporated into any hybrid vehicle 10 that is fully or partially electric powered. System 20 can be mounted in various exemplary locations of the vehicle 10. In an example, system 20 is mounted in the front or engine compartment 15. In a further example, system 20 is mounted underneath the passenger compartment 12. In an even further example, system 20 is mounted underneath the rear compartment 13. In still an even further example, system 20 extends between at least two of the front compartment) 5, beneath or through the passenger compartment 17, and the rear compartment 13.

System 10 includes at least one electric battery 18 which can be referred to as a battery module. Module 18 includes at least one individual battery cell 24. In the example shown in FIG. 3, module 18 includes a plurality of individual battery cells 24. In a further example, module 18 comprises about 10 to 50 individual battery cells. Typically, battery cells 24 are arranged or stacked together either in a vertical or horizontal stack as a series of cells 24. Battery cells 24 typically define a substantially rectangular geometry having a relatively thin side profile relative to the substantially larger flat surface. Battery cells 24 can be referred to as a “pouch cell” and this geometry can be referred to as a “notebook” configuration. In a vertical stack of the battery cells 24, each individual cell 24 lies substantially horizontal and flat and the cells 24 are stacked on top of each other. In FIG. 3, the cells 24 are aligned vertically and stacked against each other in a horizontal stack, similar to books in a book case. The cells 24 can be arranged to have a variety of non-limiting configurations. A sensor 33 can be mounted in or adjacent to module 18 to monitor the temperature of the battery. Sensor 33 is in communication with a controller 34.

Cells 24 are mounted in a casing or housing 26 forming the module 18. Module 18 combined with casing 26 can securely fit within housing 40 of FIG. 2. Casing 26 can be constructed of any suitable material. Non-conductive portions (not shown) may be included to cover exposed electrically active portions of the individual cells. In an example, a module controller (not shown) is provided and coupled to the individual cells 24 to monitor individual voltage of each of the cells 24. The controller can further be configured to balance the cells 24 to achieve desired voltage distribution. For example, if one particular battery cell is delivering higher voltage than desired, the controller can cause that cell to bleed some voltage and redistribute the voltage to a cell that is running lower voltage than desired. Moreover, the module controller can communicate the voltage measurements to a full system controller 34 that is further in communication with the temperature sensor 33 and a liquid pump 25. In FIG. 3, each battery cell 24 is spaced apart from adjacent cells 24 to form fluid flow channels 28. Channels 28 are sized and shaped to allow for a desired liquid 29 to pass between the individual cells 24.

System 20 further comprises a temperature control liquid distribution system 21. Liquid distribution system 21 is positioned adjacent and around battery module 18 and includes one or more distribution tubes or pipes 32. The distribution tube 32 or pipe is a cylindrical member having a central passageway extending therethrough. Temperature control and non-conductive liquid 29 passes through the central passageway as it travels within the system. The tube may be a singular member, or a plurality of interconnected members. A collection tray 23 is provided that is suitable for collecting temperature control liquid 29, a liquid pump 25 suitable for moving the liquid 29 from the tray 23 and over the battery module 22, a heat exchanger 27, and tubes 32 that interconnect each of the components to allow for the liquid 29 to flow from the tray to distribution ports 30 defined on the tubes 32 adjacent the battery cells 24. In the embodiment of FIG. 3, the ports 30 are positioned above battery cells 24 and the tray 23 is positioned below battery cells 24.

Pump 25 can be any mechanical pump operable to deliver liquid from a first position to a second position. In the example of FIG. 3, the pump 25 should be operable to deliver the liquid 29 from the tray 23 to a location above the height of the battery cells 24. Liquid pumps can be activated electronically via a controller 34 of the vehicle. Pumps can be sized and configured according to parameters such as liquid characteristics, distance needed to travel, and size and shape of the tubes. The tray 23 can be any suitably container for holding liquid 29. In an example, liquid tray 23 is a container configured to pool liquid towards an exit port 31 defined on surface of tray 23 to allow for liquid 29 to be pulled by pump 25 out of tray 23.

Tray 23 can define a substantially rectangular or circular geometry having upper and lower enclosing walls and side walls. The upper wall or surface of the collection tray 23 defines an opening in an example for receiving the liquid 29 from contacting the battery cells or in another example an inlet port for receiving the liquid. In an example, tray 23 includes an upper wall, opposed lower wall and sidewalls extending therebetween forming an enclosure for holding liquid 29. An inlet port is formed in the upper wall, and in this example extends between each of the side walls. The exit port 31 is formed in the side wall in this example. Other configurations of the collection tray are contemplated, depending on location, packaging and other parameters. Tube 32 is connected to tray 23 through exit port 31 to allow the liquid 29 to pass through tubes 32 being pumped by pump 25. The connection with tube 32 should be secured and prevent undesired leakage or dripping.

In the embodiment shown in FIG. 3, system 21 defines a plurality of ports 30 on tubes 32. Each port 30 allows for distribution of liquid 29 to directly contact the individual cells 24. In FIG. 3, the liquid 29 passes through channels 28 and collected in collection tray 23. Collection tray 23 defines an exit port 31 connected to pump 25 for pulling the liquid 29 out of tray 23 to pass through heat exchanger 27. Heat exchanger 27 can be configured to heat or cool liquid 29 depending on the desired temperature control of the cells 24. In this embodiment, the tray 23 is positioned below battery module 22 such that the liquid can fall or drip to the tray after contact with the individual battery cells 24. The pump 25 is positioned directly adjacent the tray 23. The liquid 29 is pumped through one or more tubes or pipes 32 that are connected to the tray 23, the pump 25, the heat exchanger 27 and out of ports 30.

In an exemplary embodiment, heat exchanger 27 is coupled to an air conditioning circuit of the vehicle to absorb the heated liquid 29. In a battery cooling embodiment, liquid 29 passes over the warmer battery cells 24 and thus transferring at least some of the heat from cells 24. Liquid 29 is collected in tray 23 defining a temperature higher than that delivered from distribution ports 30. The liquid 29 is pumped through pump 25 into heat exchanger 27 to be cooled before being delivered to distribution ports 30. The heat exchanger 27 can be a co-current flow or cross current flow exchanger depending on the desired result parameters. Heat transferred from the battery cells can be redistributed elsewhere in the vehicle where desired. For example, heat transferred from the battery cells can be redistributed into the cabin thus providing a suitable alternative use for the heat energy.

Collection tray 23 can be constructed asymmetrically to ensure dry pumps do not occur. A dry pump can be characterized as a pump with no liquid present. Therefore, air is distributed to the battery cells and no liquid heating or cooling takes place. Accordingly, tray 23 can be shaped and sized to form a collection pool at the exit port 31. In a further example, system 21 can comprise two exit ports (not shown) at opposite sides of the tray 23 with two pumps 25 (not shown) for dual side liquid 29 distribution. Liquid 32 passes through tubes or pipes 32. In this example, tubes 32 are well insulated to prevent undesired heat transfer. Tubes 32 connect pump 25 to tray 23 and heat exchanger 27. Tubes 32 further connect heat exchanger 27 to distribution ports 30.

In an even further example, a manifold (not shown) is provided to ensure relatively even liquid distribution among the plurality of ports 30. Ports 30 can be constructed to deliver liquid 29 onto battery cells 24 in a variety of techniques including but not limited to a spray, a drip, a constant pour, a mist or a combination thereof. The delivery technique employed will impact the pump selection since it impacts the degree of pressure required. In the example of FIG. 2, liquid 29 is delivered to cells 24 from above module 22. Pump 25, therefore, moves the liquid 29 from tray 23, positioned below module 22, up and above module 22. However, if a drip or pour distribution technique is utilized, then less work is required to deliver liquid through the ports 30 since less pressure or force will be needed. The pump 25 should be configured to ensure substantially even distribution among the plurality of ports 30.

Liquid 29 is a non-conductive liquid. Liquid 29 directly contacts cells 24 and thus will physically contact exposed and potentially active electrical voltage sites on the cells 24. In an example, liquid 29 is automotive transmission fluid or brake fluid. In a further example, liquid 29 is a silicon-based non-conductive fluid. In an even further example, liquid 29 is a phase change coolant like a refrigerant used in vehicle AC systems. In yet an even further example, a filter and/or a magnet is utilized in the system to remove any contaminants from the coolant.

In an example, system 20 comprises at least one temperature sensor 33 in communication with the full system controller 34. Pump 25 can also be coupled to the full system controller 34. Predetermined temperature or operating conditions can be programmed into the controller to ensure desired operating temperature of the module 22. The temperature of module 22 is measured and communicated to the full system controller 34 at predetermined intervals. When the temperature of the module 22 exceeds or falls below a predetermined threshold, the full system controller 34 can communicate to pump 25 to deliver the cooling or heating liquid 29 to the cells 24. In a further example, distribution of liquid 29 is continuous during operation of vehicle 10 with increased or decreased delivery of the fluid being managed by the full system controller 34. The full system controller 34 is configured to manage and minimize undesired temperature fluctuations.

In another example, the liquid 29 is sprayed on to the cells 24 from a side configuration (not shown). The pump 25 is configured to spray the liquid 29 on to the cells 24 from a side orientation and thus should be strong enough to substantially ensure direct contact of liquid 29 with most of the surface of the cells 24. A dual side distribution can further be employed to improve surface area coverage of cells 24. In side delivery configurations, a backstop plate (not shown) is positioned opposite the distribution ports to assist in collecting the liquid 29. In an even further example, the liquid is distributed from below the cells sprayed upward from the distribution ports. System 20 should be fully contained and unexposed to other components of the vehicle 10.

In yet another example, vehicle 10 comprises multiple modules 22 each incorporated into a system 20. The fully system controller is in communication with a hybrid controller (not shown) to manage desired battery performance and thus improves the function and performance of the overall vehicle. For example, if the voltage on the battery cells 24 is too high or the temperature is too high, the hybrid controller can instruct liquid distribution on the battery cells through distribution system 21. The hybrid controller can further reduce load on the battery to allow the battery to be properly adjusted and instead rely on power from the traditional combustion engine.

In another example, system 20 is a sealed system operable to prevent ingress of oxygen, particularly if the fluid is flammable. In yet another example, a fire suppression system is integrated (not shown) with system 20. This is particularly useful if using flammable fluids or certain battery chemistries.

In a further example, module 22 is partially or fully submerged in a liquid 29 bath (not shown). The bath is connected to at least one temperature sensor, at least one pump or a passive flow system, and at least one heat exchanger. The liquid 29 can be distributed over the cells from distribution ports from above and recycled to maintain a desired temperature of the bath and thus the module 22.

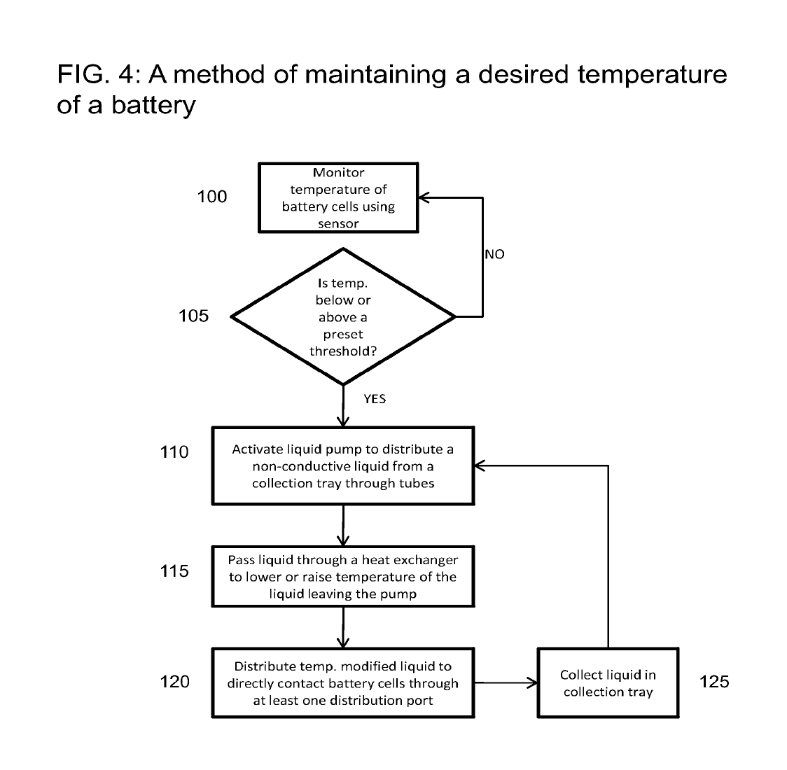

The present disclosure provides for a method as shown in a flow chart of FIG. 4 of using the system of FIG. 3. The methodology begins in block 100 with the step of sensing the temperature of the battery module. For example, the sensor 33 measures the temperature of the battery module 18. The temperature reading is communicated to a controller 34. The methodology advances to block 105 and determines if the temperature is above or below a preset threshold. If the temperature is above a preset threshold, then the methodology advances to block 110 where the controller communicates with the liquid pump 25 to begin distributing the liquid 29 from tray 24 through the tubes 32. The liquid 29 is distributed to the heat exchanger 27 to modify the liquid temperature as shown in block 115. If the temperature is below the present threshold, then the process is identical but the heat exchanger operates to warm the liquid 29 rather than cool the liquid.

The methodology advances to block 120 and the temperature modified liquid 29 leaving heat exchanger 27 is then delivered to at least one distribution port 30 where is distributed to directly contact battery cells 24. Once the liquid either cools or warms the battery cells 24, it is collected in the collection tray 23 as shown in block 125. The collected liquid 29 is then pumped by pump 25 through heat exchanger 27 and to battery cells 24 as instructed by the controller 34.

This method could be used for cooling batteries in different applications like grid energy storage or backup power supplies. In this method a non-conductive liquid is distributed through a liquid distribution system to directly contact individual battery cells to thermally modify the temperature of the battery cells in the grid energy storage or power supply environments. After contacting the battery cells, the liquid is collected in a collection tray that is coupled to a liquid pump. The liquid pump distributes the liquid through a heat exchanger that modifies the liquid before being distributed to the battery cells through one more distribution tubes. The tubes define at least one port to allow the liquid to exit the tubes and distribute to the individual cells. Additionally, the motor inverter (or other high power electronics devices like the charger) could be cooled in a similar fashion where a non conductive coolant refrigerant or fluid is pumped directly onto the power electronics.

The hybrid vehicle may include other features conventionally known for a vehicle, such as a gasoline engine, other controllers, a drive train or the like.

Many modifications and variations of the present disclosure are possible in light of the above teachings. Therefore, within the scope of the appended claim, the present disclosure may be practiced other than as specifically described.

What is claimed is:

1. A battery temperature control system for a vehicle having a battery as a power source comprising:
(a) a battery module including at least one battery cell;
(b) at least one liquid distribution tube member positioned adjacent the battery module for circulating a non-conductive liquid therethrough, wherein the liquid distribution tube member defines at least one distribution port adjacent the at least one battery cell to deliver the liquid to contact the at least one battery cell in the battery module;
(c) a collection tray connected to and positioned at one end of the liquid distribution tube member, wherein the liquid tray collects the liquid after contacting the at least one battery cell;
(d) a liquid pump in communication with the liquid distribution tube member for distributing the liquid throughout the liquid distribution tube member; and
(e) a heat exchanger disposed in the liquid distribution tube member to modify the temperature of the liquid.

2. The system of claim 1 further comprising a plurality of liquid distribution tube members interconnecting from the tray, the pump, and the heat exchanger.

3. The system of claim 1 wherein distribution port is adapted to distribute the liquid using a delivery technique selected from the group consisting of a spray, a constant pour, a mist, a drip, and a combination thereof.

4. The system of claim 1 further comprising a module controller coupled to the at least one battery cell and operable to measure voltage from the battery cell and communicate the voltage measurement to a full system controller, wherein the full system controller is operable to instruct the liquid distribution system to deliver liquid to the module to achieve desired temperature parameters of the module.

5. The system of claim 1 wherein the module includes a plurality of battery cells stacked together, wherein each cell is spaced apart from adjacent cells defining a liquid flow channel.

6. The system of claim 5 wherein the module includes between 10 and 50 battery cells.

7. The system of claim 5 wherein the liquid flow channel is configured to allow the liquid to directly contact the plurality of battery cells.

8. The system of claim 5 wherein the liquid flowing through the liquid flow channel is operable to absorb heat from the battery cell or deliver heat to the battery cell through direct contact.

9. The system of claim 1 wherein the tube system comprises a plurality of distribution ports.

10. The system of claim 9 wherein the plurality of distribution ports are spaced apart evenly along a length of the battery cells.

11. The system of claim 1 wherein the battery cell is a lithium ion battery.

12. The system of claim 1 wherein the heat exchanger is coupled to an air conditioning system.

13. The system of claim 1 wherein the non-conductive liquid is a silicon-based non-conductive fluid.

14. The system of claim 1 wherein the non-conductive liquid is selected from the group consisting of transmission fluid, brake fluid, refrigerant, and combinations thereof.

15. The system of claim 1 further comprising a filtering coupled to the tube system adapted to remove at least some contaminants in the liquid.

16. A method of maintaining a desired temperature of a battery in a hybrid or fully electric vehicle comprising the steps of:
(a) distributing a non-conductive liquid defining a temperature from a collection tray to a distribution port defined on a tube system;
(b) passing the liquid through the heat exchanger to raise or lower the temperature of the liquid;
(c) delivering the liquid through the distribution port to directly contact at least one battery cell in a battery module; and
(d) collecting the liquid distributed to the battery cell in the collection tray.

17. The method of claim 16 wherein the liquid is distributed by a liquid pump coupled to the collection tray and the tube system.

18. The method of claim 16 wherein distribution port is adapted to distribute the liquid using a delivery technique selected from the group consisting of a spray, a constant pour, a mist, a drip, and a combination thereof.

19. The method of claim 16 further comprising the step of monitoring temperature of the battery module using a sensor with a system controller and communicating with the pump to activate when the temperature of the battery module exceeds a preset threshold temperature.

20. A method of maintaining a desired temperature in a hybrid or electric vehicle comprising the steps of:
(a) distributing a non-conductive liquid defining a temperature from a collection tray to a distribution port on a tube system;
(b) passing the liquid through the heat exchanger to raise or lower the temperature of the liquid;
(c) delivering the liquid through the distribution port to directly contact electrical devices in the vehicle; and
(d) collecting the liquid distributed to the battery cell in the collection tray.
